(19) United States
(12) Patent Application Publication
(10) Pub. No.: US 2007/0226495 A1
(43) Pub. Date: Sep. 27, 2007

(54) Settlement method using a mobile terminal and system thereof

(76) Inventors: Sung Hoon Kim, Seoul (KR); Chae Heun Lee, Seoul (KR); Sun Ho Park, Seoul (KR)

Correspondence Address: QUARLES & BRADY LLP, 411 E. WISCONSIN AVENUE, SUITE 2040, MILWAUKEE, WI, 53202-4497, US

(21) Appl. No.: 11/386,318

(22) Filed: Mar. 22, 2006

(51) Int. Cl. H04L 9/00

(52) U.S. Cl. 713/168

(57) ABSTRACT

Disclosed is a settlement method using a mobile terminal and system thereof that is able to safely perform micro-payment using a mobile terminal that is able to perform a first authentication in a mobile communication system using communication subscriber information, and protect a user from a mobile terminal illegally duplicated by performing a second authentication using unique information of the mobile terminal. The system comprises: a mobile communication system for performing a first authentication using authentication information provided by a user and transmitting a first message including a call-back URL and a second message including an authentication number to the mobile terminal; and a user agent authentication server for performing a second authentication using a user agent transmitted from the mobile terminal in response to the first message and providing the mobile terminal with the authentication result.

### BACKGROUND

1. Field of the Invention

The present invention relates to a settlement method using a mobile terminal and system thereof, particularly to a settlement method using a mobile terminal and system thereof that is able to safely perform micro-payment using a mobile terminal.

2. Discussion of Related Art

Recently, owing to the development of technical knowledge relating to electronics and communication, users can get access to a web site, make purchases and use various contents related to multimedia such as music, photographs, moving pictures, emoticons and avatars, etc. These contents are purchased using online networks and communication networks, the method, which make purchases using micro payment by adding the charge to the mobile communication service fee and then settling the same, is widely used because the contents are relatively inexpensive.

It is difficult to implement a micro payment using a credit card in an electronic commercial transaction, and also a security problem thereof can be generated. But the settlement, which uses a mobile terminal for utilizing micro payment such as for usage of contents, is generally increased in the case that a mobile terminal is utilized and the payment is settled through a mobile communication network.

FIG. 1 illustrates a block diagram of a settlement method using a mobile terminal in accordance with the conventional art. The problem in accordance with the conventional art will be simply explained in reference to FIG. 1 as follows.

If a user, who subscribes to a mobile communication service, gets access to a CP (Contents Provider) server 20 using a PC (Personal Computer) 10, selects the contents to be purchased and requests the provision of the service, the CP server 20 requests an authentication as to whether the user is a valid subscriber by transmitting user information to the settlement authentication server 30.

The settlement authentication server 30 performs an authentication using user information provided from the CP server 20 and then transmits an authentication number to the user mobile terminal 40 in text message form. The user receives the authentication number, inputs the authentication number in a settlement page of the CP server 20, and the CP server 20 compares the authentication number inputted by the user and the authentication number provided from the settlement authentication server 30. The CP server 20 transmits contents requested by the user to the user and provides the settlement authentication server 30 with settlement information thereof in the case that they coincide with each other. After that, the settlement authentication server 30 adds the charge to the mobile communication fee using the settlement information and then enables a user to pay.

As describe above, according to the conventional art, in the case that a user use above-mentioned settlement service using the mobile terminal illegally duplicated, there is no method to prevent the problem thereof. Especially, because a mobile terminal is a necessity for modern people and the need of it increases daily, steeling and loss of a mobile terminal are frequent. Stolen or lost mobile terminals are used, or the illegal duplication of an electronic unique number is increased using subscriber information disclosed illegally. The damage due to the position tracing and electronic commercial transactions using an illegally duplicated mobile terminal is increased.

Accordingly, in the use of a settlement method using a mobile terminal, there is a high demand for a settlement method and system thereof using a mobile terminal, which is capable of easily uncovering the use of an illegally duplicated mobile terminal illegally duplicated and then preventing the problem thereof.

### SUMMARY OF THE INVENTION

Accordingly, it is an object of the present invention to provide a settlement method using a mobile terminal and system thereof which is able to safely perform micro-payment using a mobile terminal.

In addition, it is another object of the present invention to provide a settlement method using a mobile terminal and system thereof which is capable of performing a first authentication using mobile communication subscriber information in a mobile communication system, performing a second authentication using unique information of the mobile terminal and then protecting a user from illegally duplication of a mobile terminal.

Furthermore, it is still another object of the present invention to provide a settlement method using a mobile terminal and system thereof which is able to prevent the use of an illegally duplicated mobile terminal by performing an authentication using terminal information stored in a client information database of a mobile communication service provider when a mobile terminal is opened for service and then enables a user to freely utilize contents service.

Accordingly, it is a first aspect of the present invention to provide a settlement method using a mobile terminal, the method comprising the steps of: (a-1) a user's getting access to a contents provision server through a wire terminal and providing authentication information, and of the contents provision server receiving the service request and then providing a settlement execution with authentication information and purchase information of the user in case that the provision service of contents selected by the user is request; (a-2) the settlement execution server generating an authentication number, providing a mobile communication system with the authentication information, the purchase information and the authentication number information, and of the mobile communication system performing a first authentication using the authentication information and transmitting a call-back URL message to the user mobile terminal; (a-3) the mobile terminal confirming the call-back URL message transmitted from the mobile communication system and then transmitting a user agent including the mobile terminal information to the user agent authentication server; (a-4) the user agent authentication server performing a second authentication using the user agent including the mobile terminal information, and then providing the authentication result to the mobile communication system; (a-5) the mobile communication system transmitting a message including an authentication number to the mobile terminal in the case that the mobile terminal user is authenticated as a valid subscriber; and (a-6) the contents provision server conforming the authentication number and then providing the user with the selected contents in the case that the user provides the contents provision server with an authentication number transmitted to the mobile terminal through the wire terminal.

Preferably, the contents provision server of the step (a-1) provides the user wire terminal with at least one of a menu page, a search page and a settlement page so as to utilize the contents provision service. More preferably, the first authentication of the step (a-2) is performed by comparing mobile communication subscriber information stored in the mobile communication system and authentication information provided from the settlement execution server. Most preferably, the method further comprises the step of the mobile communication system generating approval particulars and then transmitting the same to the contents execution server after the first authentication of the step (a-2).

Moreover, the method comprises the step of the contents execution server transmitting the approval particulars to the contents provision server after the approval particulars transmission of the step (a-2). Preferably, the second authentication of the step (a-2) is performed by comparing a user agent including mobile terminal information stored when the mobile terminal is opened for service and a user agent transmitted from the mobile terminal, by the user agent authentication server. Most preferably, the method further comprises the step of the mobile communication system settling the contents transmission payment with the contents provision server, appending the contents fee when issuing a fee payment note to the mobile terminal and then charging the fee.

According to a second aspect of the present invention, there is provided a settlement method using a mobile terminal, the method comprising: (b-1) a user's getting access to a contents provision server through a wire terminal, providing authentication information, and requesting the provision service of contents selected by the user; (b-2) the contents provision server providing a mobile communication system with authentication information and purchase information of the user; (b-3) the mobile communication system performing a first authentication using the authentication information and then transmitting a call-back URL message to the user mobile terminal; (b-4) the user agent authentication server performing a second authentication using the user agent including the mobile terminal information, and then providing the authentication result to the mobile communication system in the case that the mobile terminal confirms the call-back URL message transmitted from the mobile communication system and the user agent is transmitted to the user agent authentication server from the mobile terminal; (b-5) the mobile communication system transmitting a message including an authentication number to the mobile terminal in the case that the mobile terminal user is authenticated as a valid subscriber; and (b-6) the contents provision server confirming the authentication number and then providing the user with the selected contents in the case that the user provides the contents provision server with an authentication number transmitted to the mobile terminal through the wire terminal.

Preferably, the first authentication of the step (b-3) is performed by comparing mobile communication subscriber information stored through an authentication processing unit of the mobile communication system and authentication information provided from the settlement execution server. More preferably, the method further comprises the step of the mobile communication system generating approval particulars and then transmitting the same to the contents provision server after the first authentication of the step (b-3). Most preferably, the second authentication of the step (b-4) is performed by comparing a user agent including the mobile terminal information stored at a database of a mobile communication service provider and a user agent transmitted from the mobile terminal. In the embodiment, the call-back URL message is transmitted to the mobile terminal in the case that it is confirmed whether a message is received to the mobile terminal and the user requests the message.

According to a third aspect of the present invention, there is provided a settlement system using a mobile terminal, the system comprising: a mobile communication system for performing a first authentication using authentication information provided by a user and transmitting a first message including a call-back URL and a second message including an authentication number to the mobile terminal; and a user agent authentication server for performing a second authentication using a user agent transmitted from the mobile terminal in response to the first message and providing the mobile terminal with the authentication result.

Preferably, the system comprises a settlement execution server for receiving an authentication information and purchase information provided from the contents provision server, generating an authentication number, requesting the authentication of the authentication number, and then providing the mobile communication system with settlement information transmitted from the contents provision server.

According to a third aspect of the present invention, there is provided a settlement system using a mobile terminal, the system comprising: a subscriber authentication unit for firstly authenticating whether a user is a valid subscriber of a mobile communication service using authentication information of the user; a approval processing unit for generating approval information and then transmitting approval particulars in the case that the user is a valid subscriber; a billing processing unit for receiving settlement information settled/approved from the contents provision server, generating billing information and then storing the same; a payment processing unit for settling corresponding contents payment with the contents provision server after the settlement of contents requested by the user is completed; and a message transmission unit for transmitting a message including a call-back URL to the user mobile terminal after the completion of the first authentication and transmitting a message including an authentication number to the user mobile terminal from the user agent authentication server in accordance with the second authentication result.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 illustrates a block diagram of a settlement method using a mobile terminal in accordance with the conventional art;

FIG. 2 illustrates a block diagram of a settlement method using a mobile terminal in accordance with an exemplary embodiment of the present invention;

FIG. 3 illustrates a block diagram of a mobile communication system in FIG. 2;

FIG. 4 specifically illustrates a block diagram of a settlement method using a mobile terminal in accordance with an exemplary embodiment of the present invention;

FIG. 5 illustrates a flow chart of a settlement method using a mobile terminal in accordance with an exemplary embodiment of the present invention;

FIG. 6 illustrates a block diagram of a settlement method using a mobile terminal in accordance with another exemplary embodiment of the present invention; and

FIG. 7 illustrates a flow chart of a settlement method using a mobile terminal in accordance with another exemplary embodiment of the present invention.

The following Examples are given for the purpose of illustration only and are not intended to limit the scope of this invention.

### DETAILED DESCRIPTION OF PREFERRED EMBODIMENTS

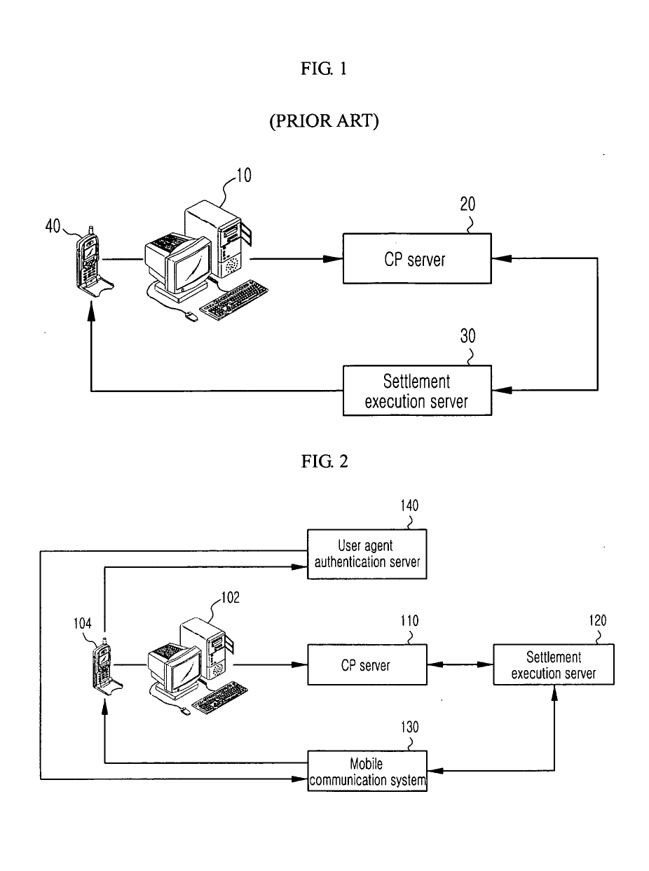

Referring to FIGS. 1 through 7, a preferable embodiment that is easily embodied by a person having ordinary skill in the same art that the present invention belongs to will be described in more detail.

Hereinafter, preferable embodiments according to the present invention will be described with reference to the accompanying drawings. Here, when one element is connected to another element, one element may be not only directly connected to another element but also indirectly connected to another element via another element. Further, irrelevant elements are omitted for clarity. Also, like reference numerals refer to like elements throughout.

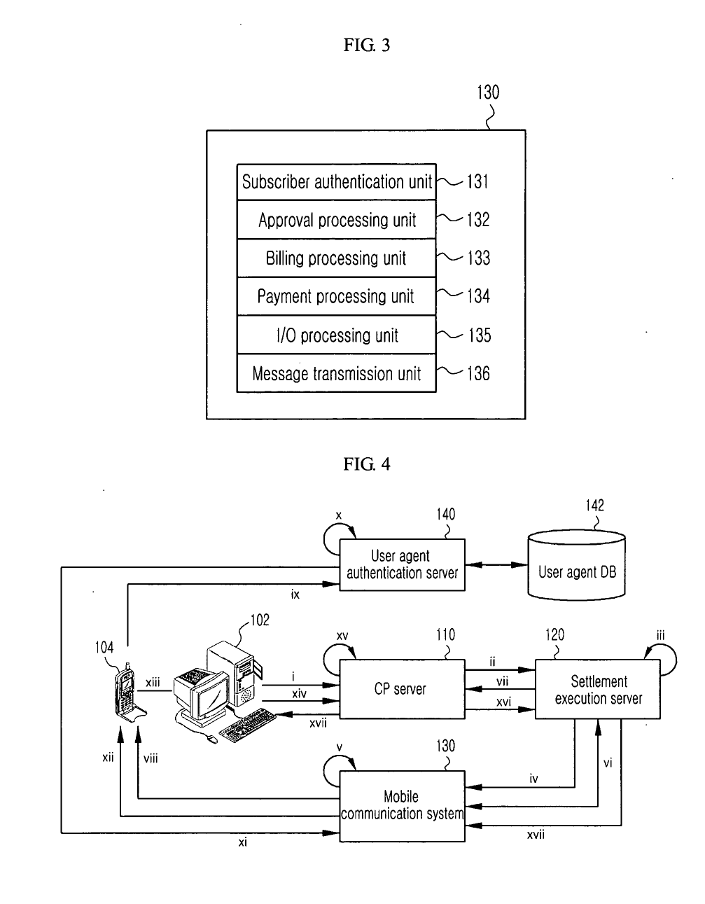

FIG. 2 illustrates a block diagram of a settlement method using a mobile terminal in accordance with an exemplary embodiment of the present invention, and FIG. 3 illustrates a block diagram of a mobile communication system in FIG. 2. Referring to FIGS. 2 and 3, a settlement system in accordance with the present invention will be described in more detail as follows.

Referring to FIG. 2, the settlement system in accordance with the present invention comprises a wire terminal 102 for being connected online with a contents provision server (hereinafter, referred to as “CP server”) through a wire communication network, a mobile terminal 104 for wireless-communicating through a wireless communication network, a CP server 120 for providing various contents services, a settlement execution server 130, a mobile communication system 140 and a user agent authentication server 150.

The wire terminal includes a PC system or a dedicated terminal which is capable of connecting with the CP server 120 through a wire communication network such as a modem for communicating and the internet connected online with a leased line, and the PC system or the dedicated terminal can download the provided contents and change the streaming data and have a protocol and a web browser and an audio and media player using the protocol. A user, who wants to receives contents, gets access to the CP server 20 which provides contents service using the wire terminal 102, selects and purchases his/her contents, and then performs the step in accordance with contents usage.

The mobile terminal 104 can be wireless-connected with other nodes through a wireless communication network such as a mobile communication network, and includes a portable phone, a PDA, a smart phone, an MP3 phone, etc which are able to transmit/receive a text message such as an SMS.

In addition, the wireless terminal 102 embeds a modem chip (MSM) or a platform, thereby to perform content provided with the wire terminal as a download method or a streaming method. The platform is a kind of middleware embedded at the wireless terminal and is used when various application programs such as an OS of a computer is performed or downloaded in a wireless terminal.

The CP server 110 provides a display window of the user with a menu page so as to use the contents service, provides a search page so as to search contents stored at a contents database in accordance with genres, classifications, age, languages, or contents, and provides a settlement page so as to settle corresponding contents in the case that a user requests the transmission of the selected contents.

In addition, the CP server 110 provides the settlement execution server with authentication information inputted by a user and purchase information selected by the user, and transmits the wire terminal with corresponding contents as the download method or streaming method in the case that authentication information inputted by a user and purchase information selected by the user coincide with each other. Herein, a data file provided as the download method or streaming method guarantees a safe transmission through a wire/wireless communication network, is packaged as DRM (Digital Rights Management) method for preventing, and is provided to the user wire terminal.

The settlement execution server 120 generates an authentication number based on authentication information and purchase information provided from the CP server 110, and plays a role in executing the settlement by transmitting the same together with the authentication information and the purchase information to the mobile communication system. The authentication information includes a social security number or a PASSWORD, information of a mobile terminal such as an MDN (Mobile Directory Number). The purchase information includes a contents value, a mobile point or a membership point.

The mobile communication system 130 is connected with a mobile communication network and performs a user authentication and a billing procedure. The mobile communication system 130 performs a first authentication for confirming whether a user is a subscriber of a mobile communication terminal using authentication information provided from the settlement execution server 120, and transmits a short message to the user mobile terminal. In addition, the mobile communication system 130 provides the user mobile terminal with an authentication number in accordance with the authentication result transmitted from the user agent (hereinafter referred to as “UA”) authentication server 140, and adds corresponding contents purchase payment to a fee payment note of the mobile communication service of a user after the user's final authentication step for corresponding contents settlement. The user agent includes unique registration information of the user mobile terminal.

Referring to FIG. 3, the mobile communication system 130 comprises a subscriber authentication unit 131, an approval processing unit 132, a billing processing unit 133, a payment processing unit 134, an I/O processing unit 135 and a message transmission unit 136, and in addition, even if not depicted in FIG. 3, the mobile communication system 130, a client information database storing client information.

The subscriber authentication unit 131 firstly authenticates whether a user is a valid subscriber of a mobile communication service using authentication information of the user, and the approval processing unit 132 completes the settlement of contents requested by a user and then accounts the payment of corresponding contents with the CP server 110.

The billing processing unit 133 receives settlement information settled/approved from the contents execution server 30, generates billing information and then stores the same, and the payment processing unit 134 accounts corresponding contents payment with the CP server 110 after the settlement of contents requested by the user is completed.

The I/O processing unit 135 transmits/receives data to/from the settlement execution server, and the message transmission unit 136 transmits a message including a call-back URL to the user mobile terminal after the completion of the first authentication in the client authentication unit 131 and transmits a message including an authentication number to the user mobile terminal from the user agent authentication server 140 in accordance with the second authentication result.

The user agent authentication server 140 performs a second authentication using unique registration information included in the user agent transmitted from the user mobile terminal. Unique information of a mobile terminal is stored at a user agent registration database of a mobile communication service provider when the user purchases the mobile terminal. The user agent authentication server 140 compares information stored in the user agent registration data and a user agent transmitted from the user mobile terminal, and then performs the authentication as to whether a user requesting contents service is a valid subscriber. The unique information of the mobile terminal 104 includes a version, a letter font, the kind of device and the opening date the embedded software program was first used.

Accordingly, the user agent authentication server 140 compares at least one of the information related to a version, a letter font, a kind of devices and the day the embedded software program was first used of the user terminal stored in the user agent registration database and user agent information provided from the user terminal, and then confirms whether the user terminal belongs to a valid subscriber or not.

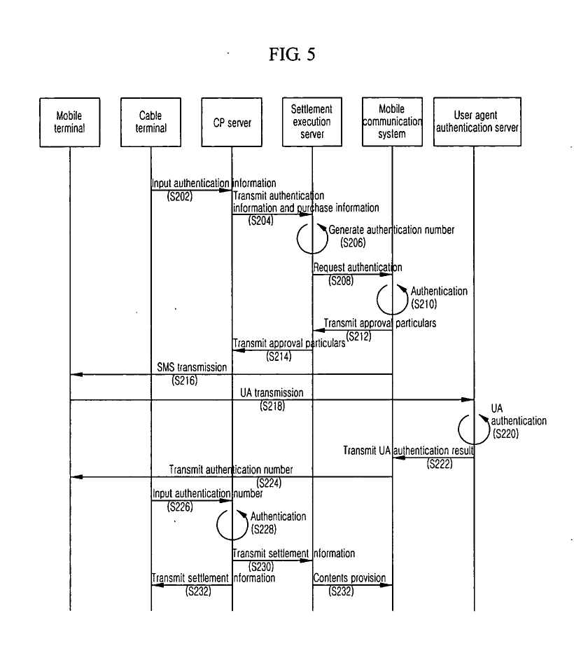

FIG. 4 specifically illustrates a block diagram of a settlement method using a mobile terminal in accordance with an exemplary embodiment of the present invention, and FIG. 5 illustrates a flow chart of a settlement method using a mobile terminal in accordance with an exemplary embodiment of the present invention. Referring to FIGS. 4 and 5, a settlement method in accordance with the present invention will be described in more detail as follows.

Referring to FIGS. 4 and 5, at first, in the case that a user who wishes to use contents service gets access to a contents provision server 110 through a wire communication network such as the Internet through a wire terminal 102, the user selects his/her contents using a menu page and a search page, etc. After that, the CP server 110 transmits corresponding contents to the user wire terminal as a download method or a streaming method after providing to the user the settlement page and the settlement thereof is completed.

If the user inputs authentication information of a social security number, a PASSWORD, and/or an MDN to be settled, etc using the settlement page for the settlement of the selected contents (i, S202), the CP server 110 transmits the authentication information, a contents value, or contents point to the settlement execution server 120 (ii, S204).

The settlement execution server 120 receives the authentication information and purchase information, generates an authentication number made up of a random number (iii, S206), transmits the authentication information together with the purchase information and the authentication number information to the mobile communication system 130, and then requests an authentication thereof (iv, S208).

The mobile communication system 130 compares the authentication information and mobile communication subscriber information, performs a first authentication as to whether a user is a valid subscriber (v, S210), provides the settlement execution server 120 with approval particulars (or authentication) (vi, S212), and then the settlement execution server 120 provides the CP server 110 with the approval particulars (vii, S214).

More specifically, the authentication is performed in the client authentication unit 131, the approval particulars are generated the authentication processing unit 132, and then the same are transmitted to the settlement execution server 120. The I/O processing unit 135 transmits/receives data to/from the settlement execution server 120.

After that, the message transmission unit 136 transmits a call-back URL message to the user mobile terminal 104 using the user mobile terminal number included in the authentication information (viii, S216). At this time, the message transmission unit 136 confirms whether a message is received by the user mobile terminal, and transmits a call-back URL message if the user requests the receipt of the message.

The mobile terminal 104 sends a user agent including unique information of the mobile terminal 104 to the user agent authentication server 140 in the case that the user confirms the message transmitted to his/her mobile terminal (viiii, S218).

The user agent authentication server 140 inquiries the user agent registration information stored in the user agent registration database 142, compares the user agent registration information and the transmitted user agent, and then performs a second authentication (x, S220). The information stored in the user agent registration database 142 includes the version, a letter font, the kind of devices and/or the date the embedded software program was first used.

After that, the user agent authentication server 140 transmits the result of the second authentication (xi, S222), the mobile communication system 130 transmits a message including an authentication number to the user mobile terminal 104 through the message transmission unit 136 in the case that the user is a valid subscriber in the second authentication result (xii, S224). On the other hand, the mobile communication system 130 stops a settlement service and transmits an authentication error message to the illegal duplicated terminal in the case that the user is not a valid subscriber in the second authentication result, namely, the user mobile terminal is illegally duplicated.

If a user inputs the authentication number received through the user mobile terminal 104 to a settlement page of the CP server 110 using (xiii) a wire terminal (xiv, S226), the CP server 110 compares the authentication number provided from the settlement execution server 120 and the authentication number inputted by the user, and then performs a third authentication (xv, S228).

The CP server 110 provides the settlement execution server 120 with settlement information in the case that the two authentication numbers coincide with each other (S230), and then the settlement execution server 120 provides the mobile communication system 130 with the settlement information (S232).

On the other hand, the CP server 110 provides corresponding contents in accordance with the requested contents to user mobile terminal 104 (S232) as a download method or a streaming method.

After that, the mobile communication system 130 accounts the payment with the CP server 110 using the settlement information through the payment processing unit 133, and appends the contents fee in case a fee payment note of the mobile terminal 104 is improved through the billing processing unit 133 and then charges the fee.

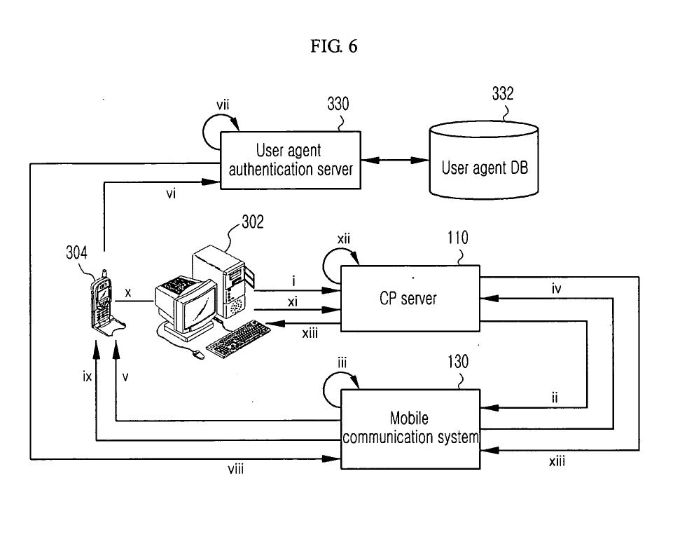

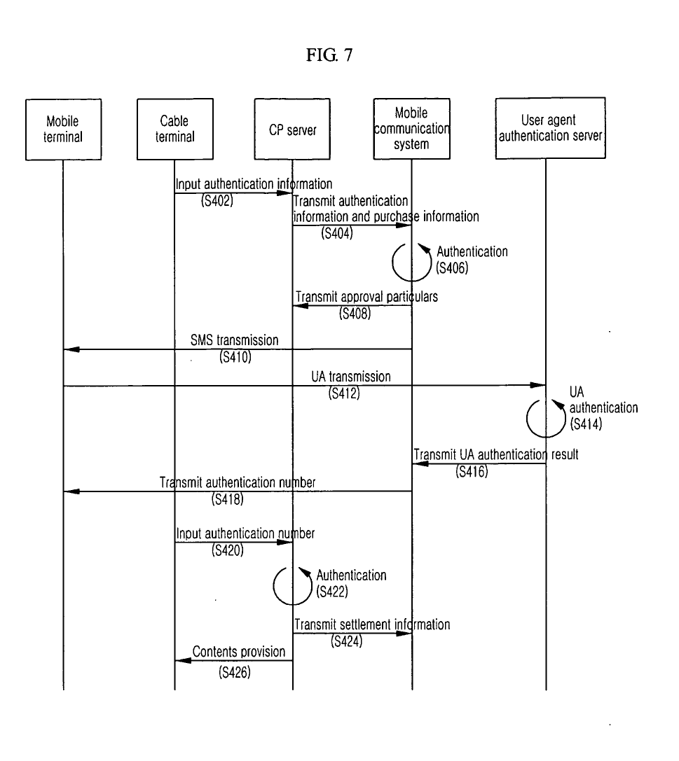

FIG. 6 illustrates a block diagram of a settlement method using a mobile terminal in accordance with another exemplary embodiment of the present invention, and FIG. 7 illustrates a flow chart of a settlement method using a mobile terminal in accordance with another exemplary embodiment of the present invention. Referring to FIGS. 6 and 7, a settlement method in accordance with another exemplary embodiment of the present invention will be described in more detail as follows.

Referring to FIGS. 6 and 7, at first, a user who wishes to use contents service gets access to a CP server 310 providing a contents provision service through a wire communication network such as the Internet using a wire terminal 302 such as a PC, and selects his/her contents using a menu page and a search page, etc. The contents include multimedia such as music, photographs, moving pictures, emoticons and avatas, etc.

After that, the CP server 310, if a settlement page is provided to the user and the settlement thereof is completed, transmits corresponding contents to the user wire terminal as a download method or a streaming method.

If the user inputs authentication information consisting of a social security number, a PASSWORD, and/or an MDN to be settled, etc using the settlement page for the settlement of the selected contents (i, S402), the CP server 310 transmits the authentication information, a contents value, or contents point to the mobile communication system 320 (ii, S404) and then requests an authentication.

The mobile communication system 320 receives the authentication information and purchase information, compares the authentication information and mobile communication subscriber information, performs a first authentication as to whether a user is a valid subscriber (iii, S406), generates approval particulars (or authentication), and then provides the CP server 110 with the approval particulars (iv, S408).

After that, the mobile communication system 320 transmits a call-back URL message to the user mobile terminal 304 using the user mobile terminal number included in the authentication information (v, S410). At this time, the mobile communication system 320 confirms whether a message is received by the user mobile terminal, and transmits a call-back URL message if the user requests the receipt of the message.

The mobile terminal 304 sends a user agent including unique information of the mobile terminal 304 to the user agent authentication server 330 in the case that the user confirms the message transmitted to his/her mobile terminal (vi, S412).

The user agent authentication server 330 inquires the user agent registration information stored in the user agent registration database 332, compares the user agent registration information and the transmitted user agent, and then performs a second authentication (vii, S414). The information stored in the user agent registration database 332 includes the version, a letter font, the kind of devices and/or the date the embedded software program was first used.

After that, the user agent authentication server 330 transmits the result of the second authentication (viii, S416), the mobile communication system 320 transmits a message including an authentication number to the user mobile terminal 304 through the message transmission unit 136 in the case that the user is a valid subscriber in the second authentication result (viiii, S418). On the other hand, the mobile communication system 320 stops a settlement service and transmits an authentication error message to the illegally duplicated terminal in the case that the user is not a valid subscriber in the second authentication result, namely, the user mobile terminal is illegally duplicated.

If a user inputs the authentication number received through the user mobile terminal 304 to a settlement page of the CP server 310 using (x) a wire terminal (xi, S420), the CP server 310 compares the authentication number provided from the mobile communication system 320 and the authentication number inputted by the user, and then performs a third authentication (xii, S422).

The CP server 310 provides the mobile communication system 320 with settlement information in the case that the two authentication numbers coincide with each other (xiii, S424), and then provides the user wire mobile terminal 304 with contents corresponding to the selected contents as a download method or a streaming method (xv, S426).

After that, the mobile communication system 320 accounts the payment with the CP server 310 using the settlement information, and appends the contents fee in case of a fee payment note of the mobile terminal 304 is issued and then charges the fee.

As described above, the present invention is capable of performing a safe settlement because user agent information including unique information of the user mobile terminal and user agent information stored in a client information database are compared and then a second authentication is performed, with the exception that authentication information inputted by a user requesting contents service and subscriber information stored in a mobile communication system are compared and then a first authentication is performed.

In addition, the present invention is able to stop a settlement service thereof in case of trying to settle using a mobile terminal illegally duplicated because the user agent information includes unique information corresponding to the mobile terminal and whether the mobile requesting the settlement is a mobile terminal of a valid subscriber or not can be confirmed.

Furthermore, the present invention is able to activate culture contents business and of course enhance the increase of the mobile communication use and the reliability of a mobile communication service provider because the damage caused by an electronic commercial transaction using a mobile terminal illegally duplicated can be prevented and then a user freely utilizes the contents service.

As described above, the present invention is capable of performing a first authentication using mobile communication subscriber information in a mobile communication system, and performing a second authentication using unique information of the mobile terminal and then protecting a user from a mobile terminal illegally duplicated.

Furthermore, the present invention is able to prevent the use of a mobile terminal illegally duplicated by performing an authentication using terminal information stored in a client information database of a mobile communication service provider when a mobile terminal is first opened for service and then enables a user to freely utilize the contents service.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A settlement method using a mobile terminal, the method comprising the steps of:
(a-1) a user's getting access to a contents provision server through a wire terminal and providing authentication information, and the contents provision server receiving the service request and then providing a settlement execution with authentication information and purchase information of the user in case of requesting the provision service of contents selected by the user;
(a-2) the settlement execution server generating an authentication number, providing a mobile communication system with the authentication information, the purchase information and the authentication number information, and the mobile communication system performing a first authentication using the authentication information and transmitting a call-back URL message to the user mobile terminal;
(a-3) the mobile terminal confirming the call-back URL message transmitted from the mobile communication system and then transmitting a user agent including the mobile terminal information to the user agent authentication server;
(a-4) the user agent authentication server performing a second authentication using the user agent including the mobile terminal information, and then providing the authentication result with the mobile communication system;
(a-5) the mobile communication system transmitting a message including an authentication number to the mobile terminal in the case that the mobile terminal user is authenticated as a valid subscriber; and
(a-6) the contents provision server conforming the authentication number and then providing the user with the selected contents in the case that the user provides the contents provision server with an authentication number transmitted to the mobile terminal through the wire terminal.

2. The method as claimed in claim 1, wherein the contents provision server of the step (a-1) provides the user wire terminal with at least one of a menu page, a search page and a settlement page so as to utilize contents provision service.

3. The method as claimed in claim 1, wherein the first authentication of the step (a-2) is performed by comparing mobile communication subscriber information stored at the mobile communication system and authentication information provided from the settlement execution server.

4. The method as claimed in claim 1, further comprising the step of the mobile communication system generating approval particulars and then transmitting the same to the contents execution server after the first authentication of the step (a-2).

5. The method as claimed in claim 4, further comprising the step of the contents execution server transmitting the approval particulars to the contents provision server after the approval particulars transmission of the step (a-2).

6. The method as claimed in claim 1, wherein the second authentication of the step (a-2) is performed by comparing a user agent including mobile terminal information stored when the open of the mobile terminal is opened for service and a user agent transmitted from the mobile terminal, by the user agent authentication server.

7. The method as claimed in claim 1, wherein in the authentication result of the step (a-5), in the case that the mobile terminal user is not authenticated as a valid subscriber, the mobile communication system transmits an authentication error message to the mobile terminal.

8. The method as claimed in claim 1, further comprising the step of the contents provision server providing the settlement execution server with settlement information, and then the settlement execution server transmitting the settlement information to the mobile communication system after the step (a-6).

9. The method as claimed in claim 8, further comprising the step of the mobile communication system settling the contents transmission payment with the contents provision server, appending the contents fee in case of issuing a fee payment note of the mobile terminal and then charging the fee.

10. A settlement method using a mobile terminal, the method comprising the steps of:
(b-1) a user's getting access to a contents provision server through a wire terminal, providing authentication information, and requesting the provision service of contents selected by the user;
(b-2) the contents provision server providing a mobile communication system with authentication information and purchase information of the user;
(b-3) the mobile communication system performing a first authentication using the authentication information and then transmitting a call-back URL message to the user mobile terminal;
(b-4) the user agent authentication server performing a second authentication using the user agent including the mobile terminal information, and then providing the authentication result to the mobile communication system in the case that the mobile terminal confirms the call-back URL message transmitted from the mobile communication system and the user agent is transmitted to the user agent authentication server from the mobile terminal;
(b-5) the mobile communication system transmitting a message including an authentication number to the mobile terminal in the case that the mobile terminal user is authenticated as a valid subscriber; and
(b-6) the contents provision server confirming the authentication number and then providing the user with the selected contents in the case that the user provides the contents provision server with an authentication number transmitted to the mobile terminal through the wire terminal.

11. The method as claimed in claim 10, wherein the first authentication of the step (b-3) is performed by comparing mobile communication subscriber information stored through an authentication processing unit of the mobile communication system and authentication information provided from the settlement execution server.

12. The method as claimed in claim 10, further comprising the step of the mobile communication system generating approval particulars and then transmitting the same to the contents provision server after the first authentication of the step (b-3).

13. The method as claimed in claim 10, wherein the second authentication of the step (b-4) is performed by comparing a user agent including the mobile terminal information stored in a database of a mobile communication service provider and a user agent transmitted from the mobile terminal.

14. The method as claimed in claim 9, wherein a response message in response to the reservation inquiry request message is a reservation inquiry response message including the state of a reservation or selling/purchase in accordance with each issue in predetermined securities.

15. The method as claimed in claim 10, further comprising the step of the contents provision server transmitting the settlement information to the mobile communication system after the step (b-6).

16. The method as claimed in claim 10, wherein the call-back URL message is transmitted to the mobile terminal in the case it is confirmed that whether a message is received by the mobile terminal, and the user requests the message.

17. A settlement system using a mobile terminal, the system comprising:
a mobile communication system for performing a first authentication using authentication information provided by a user and transmitting a first message including a call-back URL and a second message including an authentication number to the mobile terminal; and
a user agent authentication server for performing a second authentication using a user agent transmitted from the mobile terminal in response to the first message and providing the mobile terminal with the authentication result.

18. The system as claimed in claim 17, further comprising a settlement execution server for receiving authentication information and purchase information provided from the contents provision server, generating an authentication number, requesting the authentication of the authentication number, and then providing the mobile communication system with settlement information transmitted from the contents provision server.

19. A settlement system using a mobile terminal, the system comprising:
a subscriber authentication unit for firstly authenticating whether a user is a valid subscriber of a mobile communication service using authentication information of the user;
a approval processing unit for generating approval information and then transmitting approval particulars in the case that the user is a valid subscriber;
a billing processing unit for receiving settlement information settled/approved from the contents provision server, generating billing information and then storing the same;
a payment processing unit for settling corresponding contents payment with the contents provision server after the settlement of contents requested by the user is completed; and
a message transmission unit for transmitting a message including a call-back URL to the user mobile terminal after the completion of the first authentication and transmitting a message including an authentication number to the user mobile terminal from the user agent authentication server in accordance with the second authentication result.
